(19) United States
(12) Patent Application Publication
(10) Pub. No.: US 2020/0312190 A1
(43) Pub. Date: Oct. 1, 2020

(54) SYSTEMS AND METHODS FOR IOT CONNECTED STEM LEARNING KIT

(71) Applicant: Joulez, Inc., Cambridge, MA (US)

(72) Inventors: Stephanie Rowe, Cambridge, MA (US); Brian Hack, Somerville, MA (US)

(21) Appl. No.: 16/826,741

(22) Filed: Mar. 23, 2020

Related U.S. Application Data
(60) Provisional application No. 62/825,489, filed on Mar. 28, 2019.

(51) Int. Cl. G09B 23/00; G16Y 40/30; G16Y 30/00

(52) U.S. Cl. CPC G09B 23/00; G16Y 30/00; G16Y 40/30

(57) ABSTRACT

An IoT connected educational system can include an application executing on a client device, a hub that performs input, communication, and processing functions, and at least one interactive device connected with the hub or the application. The hub can include at least one user input device, a processing circuit, and a communications circuit. The processing circuit can receive a user input via the at least one user input device and generate a control signal to control operation of the at least one interactive device based on the received user input. Each interactive device can include a body coupled to at least one moving component, an actuator coupled to a drive system coupled to each moving component, a plurality of lighting elements, a plurality of input sensors, a communications circuit, and a control system to drive the various inputs and outputs. A processing circuit of the interactive unit can receive the control signal and control operation of at least one of the actuator or the lighting elements based on the control signal. The interactive devices can take on a number of forms that would be interesting for a child's toy, including but not limited to flowers, insects, animals, vehicles, or other figurines.

### RELATED APPLICATION

The present application claims the benefit of and priority to U.S. Provisional Application No. 62/825,489, titled “SYSTEMS AND METHODS FOR IOT CONNECTED STEM LEARNING KIT” and filed Mar. 28, 2019, incorporated herein by reference in its entirety for all purposes.

### BACKGROUND

The present disclosure relates generally to the field of Internet of Things (IoT) devices. More particularly, the present disclosure relates to systems and methods for an IoT connected science, technology, engineering, art, and math (“STEAM”) learning kit.

Educational devices, including toys and kits that can be assembled by users, can enable users to develop helpful hands-on skills and learning approaches. Such devices can have mechanical and electrical components intended to be assembled together in a manner that teaches users the skills associated with the assembly and knowledge of the components.

### SUMMARY

An aspect of the present disclosure is an IoT connected educational system. The system can include a hub that executes input, communication, and processing functions, and one or more interactive devices connected to the hub. For example, the hub can include at least one user input device, a processing circuit, and a communications circuit. The processing circuit can receive a user input via the at least one user input device and generate a control signal to control operation of the at least one interactive device based on the received user input. Each interactive device can include a body coupled to one or more moving components, an actuator coupled to a drive system coupled to each moving component, a plurality of lighting elements, a plurality of input sensors, and a control system to drive various inputs and outputs of the interactive device. A processing circuit of the interactive device can receive the control signal and control operation of at least one of the actuator or the lighting elements based on the control signal. The processing circuits of the hub or the interactive device may be programmed by and operated responsive to instructions received from a remote device, such as an application executing on a remote device. The interactive devices can take on a number of forms that would be interesting for a child's toy, including but not limited to insects, animals, vehicles, or other figures. Various aspects of the present disclosure describe examples of systems that include interactive devices implemented in an interactive device form factor, such as to enable a user to assemble a butterfly wall; features of various examples described herein can be used to implement various form factors of interactive devices.

Another aspect of the present disclosure is a method for assembling an IoT connected educational system. The method can include coupling one or more processing circuits to a hub housing. The method can include coupling at least one user input device to the one or more processing circuits. The method can include coupling, for each of a plurality of interactive devices, one or more processing circuits, a power supply, an actuator, and a drive system to a body of the interactive device. The method can include coupling a pair of wings to the base and the drive system. The method can include coupling each butterfly to the hub.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram of a butterfly wall system according to an implementation of the present disclosure.

FIG. 2 is a perspective view of a hub of a butterfly wall according to an implementation of the present disclosure.

FIG. 3 is a perspective view of the hub of FIG. 2 including user input components according to an implementation of the present disclosure.

FIG. 4 is a perspective view of the hub of FIG. 2 including a cover according to an implementation of the present disclosure.

FIG. 5 is a perspective view of a butterfly in a partially assembled state according to an implementation of the present disclosure.

FIG. 6 is a perspective view of a base of the butterfly of FIG. 5 according to an implementation of the present disclosure.

FIG. 7 is a detailed perspective view of the base of the butterfly of FIG. 5 according to an implementation of the present disclosure.

FIG. 8 is a detailed perspective view of the base, wing hubs, and wing segments of the butterfly of FIG. 5 according to an implementation of the present disclosure.

FIG. 9 is a bottom view of the wing hub of the butterfly of FIG. 5 according to an implementation of the present disclosure.

FIG. 10 is a bottom view of the wing hub of the butterfly of FIG. 5 according to an implementation of the present disclosure.

FIG. 11 is an end view of a drive system of the butterfly of FIG. 5 wing hub of the butterfly of FIG. 5 according to an implementation of the present disclosure.

FIG. 12 is a detailed perspective view of the drive system of FIG. 11 according to an implementation of the present disclosure.

FIG. 13 is a detailed end view of the drive system of FIG. 11 depicting wings in a first position according to an implementation of the present disclosure.

FIG. 14 is a detailed end view of the drive system of FIG. 11 depicting wings in a second position according to an implementation of the present disclosure.

FIG. 15 is an end view of a drive system including a cam having multiple maximum and minimum radii according to an implementation of the present disclosure.

FIG. 16 is a flow diagram of a method for assembling a butterfly wall according to an implementation of the present disclosure.

### DETAILED DESCRIPTION

The present solution can enable a user to build knowledge and confidence across identity, vocabulary, skills, and tribe, such as by facilitating an introduction to computer science and engineering via programming, electrical, mechanical, and lighting technologies. For example, the present solution can enable learning opportunities for technical concepts such as creating colors with red, green, and blue (RGB) light emitting diodes (LEDs), programming motors to mimic movements such as butterfly wing movement, and hands-on building of technical devices, all in a non-intimidating way. The present solution can enable users to learn science, technology, engineering, art, and mathematics (STEAM) concepts.

The present solution can facilitate learning and confidence-building through interaction with devices requiring a skill level that balances between being too challenging and too easy. Devices of the present solution can be programmed to execute functions such as mechanical movements or light shows, which can be transmitted to other devices to be performed by those devices, such as via an electronic application executable on a personal electronic device (“app”).

In some implementations, the present solution can include a kit that a user can assemble into a system, such as an IoT connected educational system. The kit can include mechanical, electrical, and decorative components. For example, the kit can include a hub, which may include processing circuitry; a plurality of structural components (e.g., interactive device structure components, such as structure components for various numbers of interactive devices, including but not limited to one to five or more interactive devices); one or more cables with connectors to connect the structural components to the hub; decorative pieces; and the app. The kit can be assembled to provide an IoT connected educational system, such as a butterfly wall, which can be easily and removably mounted to a wall. The components of the kit can be provided with visual cues and/or graphic written instructions to guide the assembly process. The kit can include color coded, polarized connectors, which rely on both visual and physical cues (e.g. snapping) to give users feedback that they are assembling the butterfly wall correctly. The butterfly wings can be built and decorated by the user with a variety of appropriate materials (e.g., markers, stickers, jewels, fabrics and other creative/craft materials). The kit can include assembly tools, such as screwdrivers (e.g., Philips head screwdrivers), that are sized smaller than typical tool sizes to be more easily manipulated by a child user. The user can assemble various portions of the kit to provide the assembled system, such as by assembling the hub, assembling each interactive device, and coupling each interactive device with the hub.

Once the kit is assembled, the user can connect the system to the app, by which functionality such as wing movement, lighting patterns, and sensors can be programmed and controlled. Visual effects can be controlled using physical controls or via programming through the app. Via the app or manual controls of the system, the interactive devices can be controlled independently, serially, or as a group. The present solution can be modular, such that structural components, LEDs, and sensors (e.g., motion, temperature sound) can be swapped in and out. The present solution can enable interactions between devices through user programmed functionality as well as software/firmware updates.

The interactive devices can be manipulated to move in various manners. For example, in butterfly wall implementations, the butterfly wall can be configured to induce a flapping motion in the wings of the butterfly, and to create various lighting effects using LEDs. The present solution can enable inner workings of the hub and interactive devices to be visible to the user as a learning experience, but then hide the inner workings after assembly so as to make the system seem “magical.”

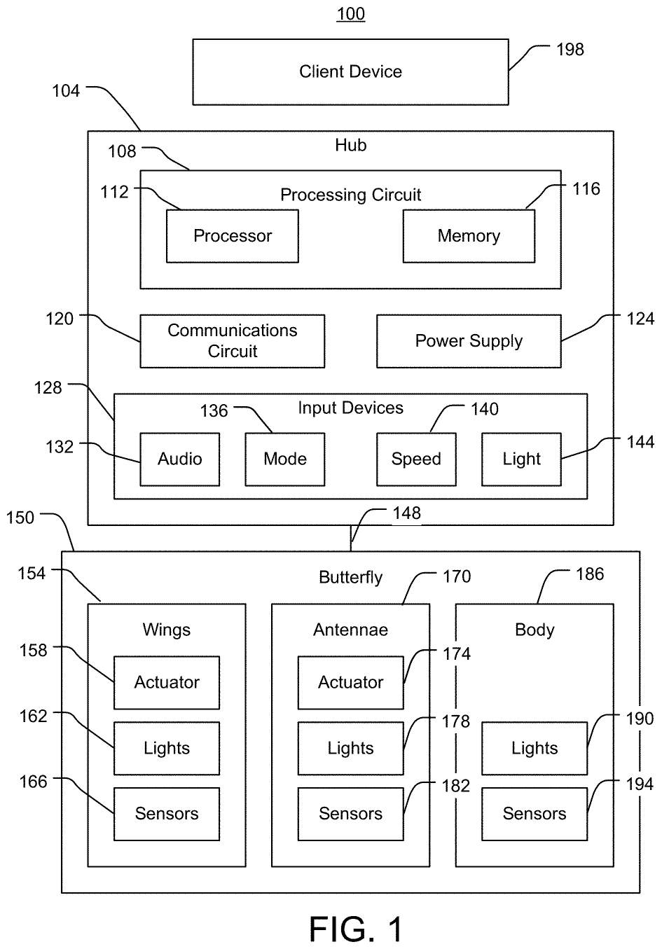

Referring now to FIG. 1, a block diagram of a system 100 is depicted. The system 100 can be used to implement an IoT connected educational system, such as a butterfly wall. The system 100 includes a hub 104 that communicates with one or more interactive devices 150, and may also communicate with a client device 198, which may include a personal electronic device. The hub 104 and interactive devices 150 can be provided as a kit to be assembled by a user. The hub 104 can include a housing to support various components of the hub 104.

The hub 104 includes a processing circuit 108 including a processor 112 and memory 116. The processing circuit 108 can be implemented using any of a variety of processing electronics and microcontrollers. For example, the processing circuit 108 can be implemented using a printed circuit board (PCB). The PCB can be custom built. The processing circuit 108 can be compatible with various systems, such as ARDUINO. The processing circuit 108 can be implemented using a microcontroller, such as a RASBERRY PI device, an ADAFRUIT FEATHER device, or an ARDUINO device. Processor 112 can be a general purpose or specific purpose processor, an application specific integrated circuit (ASIC), one or more field programmable gate arrays (FPGAs), a group of processing components, or other suitable processing components. Processor 112 can execute computer code or instructions stored in memory 116 or received from other computer readable media (e.g., CDROM, network storage, a remote server, etc.). Memory 116 can include one or more devices (e.g., memory units, memory devices, storage devices, etc.) for storing data or computer code for completing or facilitating the various processes described in the present disclosure. Memory 116 can include random access memory (RAM), read-only memory (ROM), hard drive storage, temporary storage, non-volatile memory, flash memory, optical memory, or any other suitable memory for storing software objects or computer instructions. Memory 116 can include database components, object code components, script components, or any other type of information structure for supporting the various activities and information structures described in the present disclosure. Memory 116 can be communicably connected to processor 112 via processing circuit 108 and may include computer code for executing (e.g., by processor 132) one or more processes described herein. When processor 112 executes instructions stored in memory 116, processor 112 configures the processing circuit 108 to complete such activities. The processing circuit 108 can control operation of components of the system 100 as described herein.

The hub 104 includes a communications circuit 120, which can be used to communicate with the interactive devices 150, the client device 198, and various other devices. The interactive devices 150 may include communications circuits that are similar or identical to the communications circuit 120. The communications circuit 120 can include wired or wireless interfaces (e.g., jacks, antennas, transmitters, receivers, transceivers, wire terminals) for conducting data communications with various systems, devices, or networks. For example, the communications circuit 120 can include an Ethernet card and port for sending and receiving data via an Ethernet-based communications network. The communications circuit 120 can include a WiFi transceiver for communicating via a wireless communications network. The communications circuit 120 can communicate via local area networks (e.g., a building LAN), wide area networks (e.g., the Internet, a cellular network), or conduct direct communications (e.g., NFC, Bluetooth). The communications circuit 120 can conduct wired or wireless communications. For example, the communications circuit 120 can include one or more wireless transceivers (e.g., a Wi-Fi transceiver, a Bluetooth transceiver, a NFC transceiver, a cellular transceiver). The processing circuit 108 can communicate with a remote network (e.g., an internet protocol network) using the communications circuit 120.

In some implementations, the communications circuit 120 communicates with the client device 198. For example, the communications circuit 120 can communicate using a WiFi or Bluetooth circuit with a corresponding WiFi or Bluetooth circuit of the client device 198, such as to transmit data to and receive data from an application executing on the client device 198. In some implementations, the communications circuit 120 includes a cable 148 to communicate with interactive devices 150 as described herein. The cable 148 can communicate control signals from the processing circuit 108 to the interactive devices 150, receive status data and sensor data from the interactive devices 150, and provide power to the interactive devices 150 (e.g., from power supply 124). The cable 148 can include a wire-to-board connector. The cable 148 can have lighting elements such as integrated LEDs and/or optical fiber, including optical fiber that can emit light from an end or a side to enable desired aesthetic effects. The connectors on the cable 148 can be polarized, such as to prevent incorrect assembly.

The hub 104 can include a power supply 124. The power supply 124 can include a portable power supply, such as a battery. The power supply 124 can include a charging interface, such as a port that opens to an outside of the hub 104 to enable a power cable or charging cable (not shown) to be connected to the power supply 124 to charge the power supply 124. In some implementations, using a portable power supply can facilitate the portability of the system 100 by enabling the hub 104 (and thus attached interactive devices 150) to be moved. In some implementations, the power supply 124 includes an interface or adapter that can connect to mains power (e.g., via a wall outlet), including to charge the power supply 124.

The hub 104 includes a plurality of input devices 128. The input devices 128 can include various types of switches or buttons. The input devices 128 can receive user inputs, and the processing circuit 108 can process the received user inputs 128 to control operation of the interactive devices 150 and components thereof. The input devices 128 can include potentiometers that convert manual input into a corresponding output signal representative of a magnitude of the manual input. The input devices 128 can include a power switch or an on/off switch.

In some implementations, the hub 104 includes an audio input device 132. The audio input device 132 can include a microphone. The audio input device 132 can receive audio information and provide an audio signal to the processing circuit 108 based on the audio information. The hub 104 can include an audio output device, such as a speaker.

The hub 104 can include a mode input device 136, such as a mode switch. The mode input device 136 can receive a mode input indicative of a selected mode of operation, and the processing circuit 108 can receive the mode input and control operation of a mode of the interactive devices 150 based on the mode input.

The hub 104 can include a speed input device 140. In some implementations, the speed input device 140 includes a potentiometer. The speed input device 140 can receive a speed input indicative of a selected speed of operation of the interactive devices 150 (e.g., wing speed), and the processing circuit 108 can receive the speed input and control operation of the speed of the interactive devices 150 based on the speed input.

The hub 104 can include one or more light control input devices 144. The interactive devices 150 may include various lights implementing various color channels, including but not limited to various combinations of red, green, blue, black (e.g., blacklight), or white colored lights. The light control input devices 144 can be individually assigned to specific color channels, such as red, green, and blue color channels. For example, the hub 104 can include a first light control input device 144 to control a red color channel, a second light control input device 144 to control a green color channel, and a third light control input device 144 to control a blue color channel. The processing circuit 108 can receive one or more light control inputs from the one or more light control input devices 144, and control respective LEDs (e.g., colors thereof) of the interactive devices 150 based on the light control inputs.

The processing circuit 108 can be used to implement a variety of input, data processing, control, and output functions for the hub 104 and interactive devices 150, using any of a variety of electronic circuit arrangements. For example, the processing circuit 108 can include a plurality of PCBs that execute various functions of the hub 104. For example, the processing circuit 108 can include a first PCB that receives power from the power supply 124 (e.g., via a barrel plug jack), and transmits power and control signals to the interactive devices 150. The processing circuit 108 can include a second PCB that operates as a microcontroller, such as an ADAFRUIT FEATHER microcontroller. The processing circuit 108 can include a third PCB that operates the audio input device 132. The processing circuit 108 can include a fourth PCB that operates the mode switch input device 136 and/or the power switch. The fourth PCB can include at least one status indicator to indicate at least one of a power status or a mode status, such as at least one LED (which can be coupled to respective lightpipes to emit light outside of the hub 104). The processing circuit 108 can include a plurality of fifth PCBs that operate the potentiometers of the speed input device 140 and the light control input devices 144. The first PCB can include physical connection interfaces to the other PCBs (e.g., pin interfaces; socket interfaces). By separating these functions into distinct PCBs, the system 100 can enable a user to learn the relationships between each function and the hardware that performs the function, such as to more easily troubleshoot individual functions. The size of the hub 104 can correspond to a size of hardware of the processing circuit 108, such as to enable the hub 104 to house PCB(s) of the processing circuit 108 and to orient other components that couple to the processing circuit 108. For example, the hub 104 can be sized in a manner corresponding to the first PCB having approximately 10 square inches of area. Various functions described with reference to the processing circuit 108 and other components of the hub 104, such as to control the interactive devices 150, may be executed directly or indirectly responsive to instructions received from the client device 198.

Referring further to FIG. 1, the system 100 can include a plurality of interactive devices 150. For example, the system 100 can include various numbers of interactive devices 150, such as three interactive devices 150, which may include moving components 154, 170, and a body 186. In some implementations, such as when used to implement a butterfly wall system, each interactive device 150 can include at least one moving component (e.g., wing) 154, at least one moving component (e.g., antenna) 170, and the body 186. In some implementations, each interactive device 150 includes two wings 154, two antennae 170, and the body 186. Each interactive device 150 can communicate with the hub 104 using at least one of a corresponding cable 148 or a wireless connection to the communications circuit 120. In some implementations, the interactive devices 150 are communicatively coupled in series (e.g., daisy-chained), such that a first cable 148 connects the hub 104 to a first interactive device 150, a second cable 148 connects the first interactive device 150 to a second interactive device 150, and a third cable 148 connects the second interactive device 150 to a third interactive device 150 (and so on as additional interactive devices 150 are provided). The interactive devices 150 can communicate using wireless connections. Each interactive device 150 can be removably attached to a wall, such as by having adhesive surfaces or a fastener.

Each interactive device 150 can include one or more processing circuits 196, which can be provided with various components of the interactive device 150, such as the moving components 154, moving components 170, or body 186. The processing circuits 196 can be implemented using PCBs; for example, each interactive device 150 can include a first PCB coupled to the body 186, a second PCB that performs motor control functions of the wings 154, and two third PCBs that operate lights of the wings 154. The PCBs may be coupled with one another in various ways. For example, plated contact pads, spring-loaded connector pins, snap fingers, spring pin connectors, flat flex cables, and various other connection devices may be used to connect PCBs together, including for communication power and control signals. The interactive device 150 may include a motion or proximity sensor, which can be used to detect user movements corresponding to instructions for operating the system 100.

The at least one wing 154 can be removably attached to the body 186. As such, various sizes and shapes of wing segments 508a, 508b can be interchangeably attached to the body 186 to enable customization of the interactive device 150.

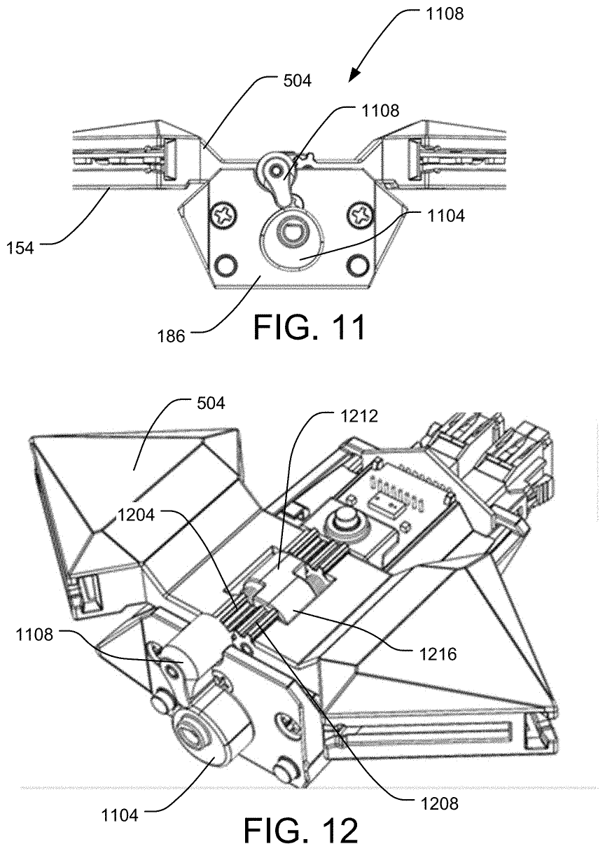

Each wing 154 can include or be coupled with an actuator 158. The actuator 158 can cause motion of the wing(s) 154. For example, the processing circuit 108 can transmit a speed control signal to the actuator 158 to control operation of the wing(s) 154. In some implementations, each wing 154 is coupled to a corresponding actuator 158. In some implementations, a single actuator 158 is used to drive both wings 154. As an example, the actuator 158 can include a direct current (DC) motor, that rotates responsive to the speed control signal to cause motion of the wing(s) 154. The actuator 158 can be soldered to the first PCB of the body 186 using jumper wires. The actuator 158 can be sized to drive the drive system 1100 described with reference to FIGS. 11-14, while operating in a range that generates relatively little noise. Various actuators 158 can be used to facilitate motion of the wings 154 while maintaining appropriate noise levels.

Each wing 154 includes at least one light 162 (e.g., LED light). The processing circuit 108 can control operation of the light 162, such as to control the color of the light 162 based on red, green, blue, white, or black signals received from the light control input devices 144 (or the client device 198). In some implementations, each wing 154 includes an LED PCB coupled to a plurality of lights 162. In some implementations, the processing circuit 108 controls groups of LEDs (e.g., groups of two or three LEDs) as a single unit (e.g., via a light control signal provided to the LED PCB), so that the LEDs will display the same color and intensity of light. In some implementations, the processing circuit 108 independently controls one or more of the plurality of lights 162, so that portions of each wing 154 may have differing colors and intensity of light. Various LEDs described herein can include plug-in lenses to enable desired lighting patterns to be generated.

Each wing 154 can include one or more sensors 166. The wing 154 can include a light sensor 166 that detects light (e.g., detects an intensity of light) and outputs an indication of the detected light. The wing 154 can include a motion sensor 166, such as an optical, infrared (IR), or microwave proximity sensor, to output an indication of motion. The interactive device 150 can include an audio sensor 166 to detect sound and output an indication of the detected sound.

The processing circuit 108 can control operation of the wings 154 and the lights 162. For example, the processing circuit 108 can control operation of the actuator 158 to control at least one of a span of motion or a speed of motion of each wing 154. The processing circuit 108 can control at least one of a color, a flash mode (e.g., light or flash patterns), a pulse mode (e.g., blinking patterns), or a speed of operation of the lights 162. The processing circuit 108 can control operation of the wings 154 and lights 162 responsive to input signals received from the input devices 128.

Each antenna 170 can include a light guide, such as a fiber optic cable that receives light from a light source 178 (e.g., LED) and outputs the received light. The antenna 170 can include an actuator 174 that moves the antenna 170. The antenna 170 can include one or more sensors 182, similar to the sensors of the wing 154, such as to detect light, sound, and/or motion.

The body 186 can be sized to receive the actuator 158 and corresponding drive mechanisms, as well as electronic components (e.g., PCBs) and connection cables 148. For example, the shape/geometry of the body 186 can be driven by design concepts as well as the components that fit within the body 186, such as the DC motor of the actuator 158, and features of the drive mechanism coupled to the actuator 158. In some implementations, the cables 148 are relatively large, so that they can be connected and disconnected many times without breaking, and include a latching feature large enough to be easily manipulated by a user. For example, wire-to-board connectors can be used, such as connectors having a vertical orientation. The body 186 can include lights 190 and sensors 194, similar to the lights and sensors of the moving component 154.

Referring further to FIG. 1, the client device 198 can include a processing circuit that executes an application to control operation of the at least one interactive device 150. The client device 198 may control operation of the at least one interactive device 150 directly or indirectly via the hub 104. For example, the client device 198 can receive user input instructions and generate control signals based on the user input instructions to provide to the processing circuit 108 of the hub 104 to cause the processing circuit 108 to control operation of the at least one butterfly 150 based on the control signals. The application executed by the client device 198 can have various levels of complexity, which the application can modify based on identifying an expertise level of the user. For example, a first version of the application can use block style programming, while more complex versions can provide for more complex programming operations. The application can present a user interface indicating control elements such as lighting, wing movement span, and wing movement speed, receive user inputs via the control elements, and generate the control signals based on the received user inputs.

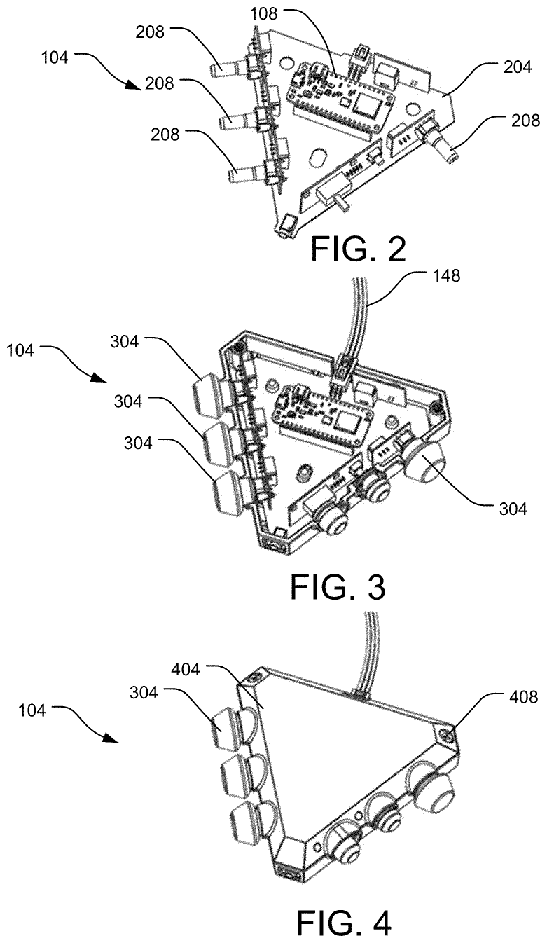

Referring now to FIGS. 2-4, an implementation of the hub 104 is depicted. The hub 104 supports the processing circuit 108, which can be implemented using a PCB. The hub 104 can include a plurality of potentiometers 208, which can receive inputs corresponding to speed, light pattern, and color control by the processing circuit 108. The hub 104 can include a plurality of switch elements 304, such as knobs, that can be manipulated by a user to operate corresponding potentiometers 208. The hub 104 can include various switch elements 304, such as sliders (e.g., to operate slide element 210) or push buttons (e.g., to operate push element 212), that control various functions of the system. The hub 104 can include a cover 404 that covers the electronic components of the hub 104, and that can be secured using fasteners 408.

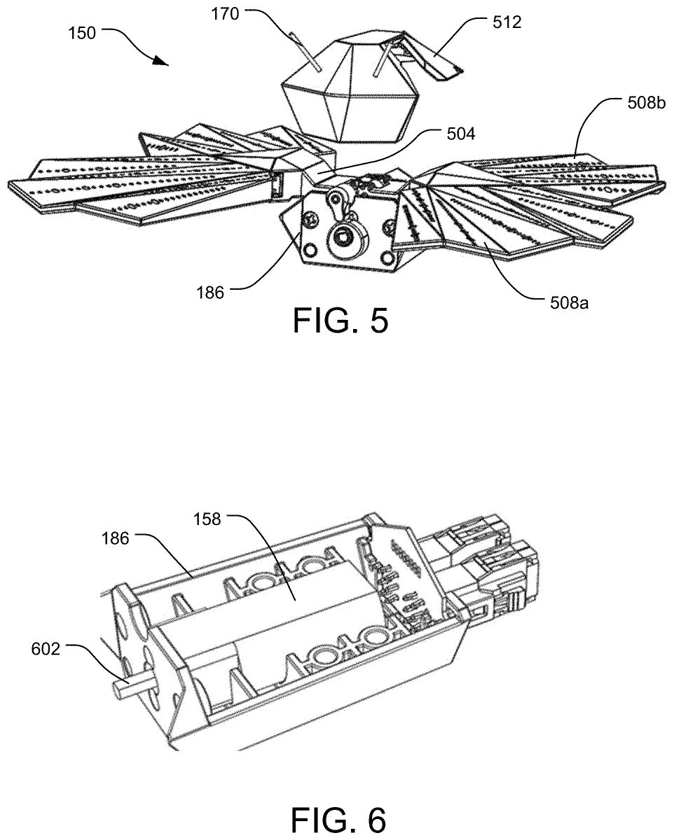

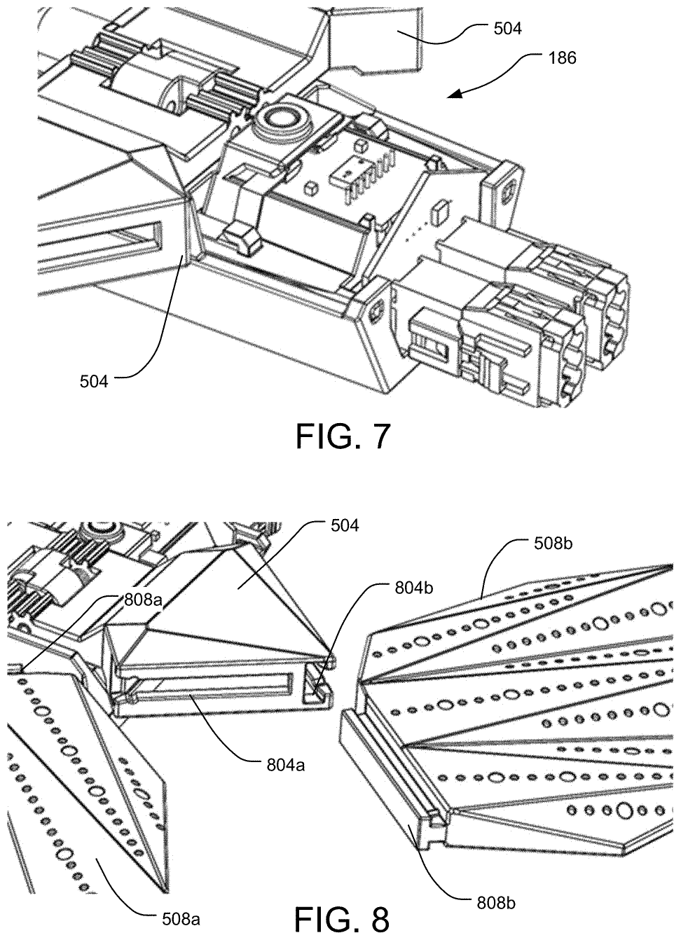

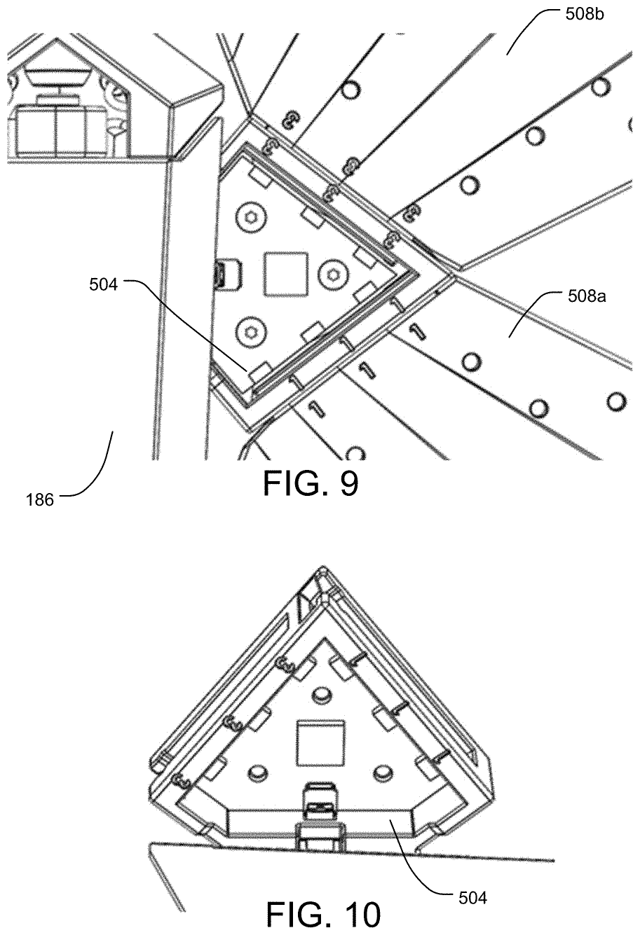

Referring now to FIGS. 5-10, an implementation of the interactive device 150 is depicted in which the moving components 154 are implemented as wing components. The interactive device 150 can include the body 186, which is coupled to a pair of wing hubs 504 on a first side (e.g., left side) and a second side (e.g., right side) of the body 186. Each wing hub 504 can be coupled to at least one wing segment 508, such as a wing segments 508a, 508b, 508c, and 508d. The wing segments 508 The body 186 can receive the actuator 158. The actuator 158 can rotate a shaft 602 coupled to the actuator 158. The actuator 158 can drive operation the wing segments 508 through various components, such as gears or linkages.

The interactive device 150 includes a cover 512 that can be secured to the body 186 to cover the actuator 158 and electronic components of the body 186. In some implementations, the cover 512 includes the antennae 170. For example, the antenna 170 can be fiber optic cables that are assembled into the cover 170. The wing 154 can include LEDs that align with input faces of the fiber optic cables when the cover 512 is in place. The fiber optics capture the light from the LEDs and route it through the cover 512 to output surfaces of the antennae 170. The cover 512 can be removably attached to the body 186 and can be attached via snaps, screws, magnets, or other permanent or non-permanent attachment mechanisms.

The wing hub 504 can receive each wing segment 508. Various approaches and mechanisms can be used to couple the wing segments with the wing hub 504. For example, the wing hub 504 includes a first slot 804a that receives the first wing segment 508a, and a second slot 804b that receives the second wing segment 508b. The first wing segment 508a can include a slot member 808a, which may be T-shaped, to be received by the first slot 804a, and the second wing segment 508b can include a slot member 808b, which may be T-shaped, to be received by the second slot 804b. In some implementations, a side of the first wing segment 508a including the slot member 808a can be longer than the slots 804a so that the first wing segment 508a at least partially covers an end of the second slot 804b to prevent the second wing segment 508b from moving out of the second slot 804b. In some implementations, at least one of each respective slot 804a (804b) or wing segment 508a (508b) includes a protrusion to enable the wing segment 508a (508b) to snap into place in the slot 804a (804b).

The present solution can use various mechanical or electromechanical mechanisms to create motion in the moving components 154. For example, as described below with reference to FIGS. 11-14, the present solution can use a DC motor driving a radial cam to create the flapping motion in the wings 154. The present solution can create a large range of motion relative to the size of the actuator while also enabling a user to participate in the assembly of the drive mechanism, providing a learning opportunity. For example, the radial cam can enable a user to see the installation process, without being large and obtrusive.

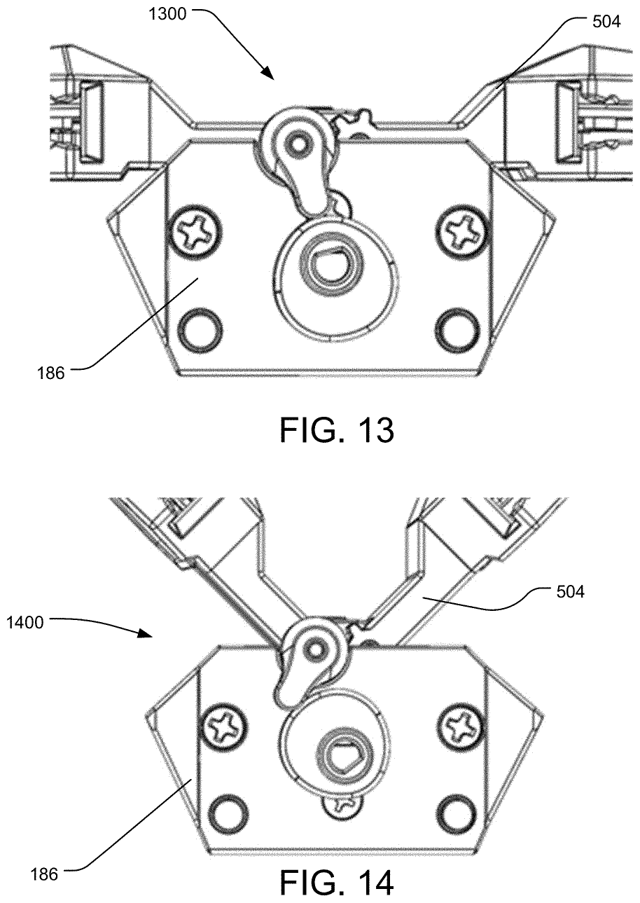

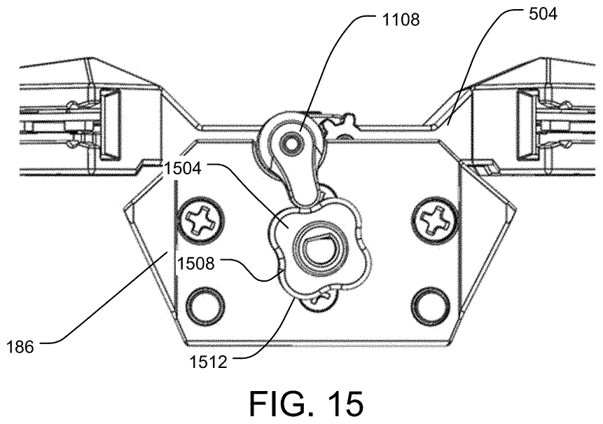

Referring now to FIGS. 11-14, an implementation of a drive system 1100 to enable flapping of the wings 154 is depicted. The drive system 1100 can be implemented as a cam follower system. In various embodiments, the drive system 1100 can be implemented using linkages coupled to a motor, electromagnetic systems, or others. The drive system 1100 includes a cam 1104 coupled to the shaft 602 that is driven by the actuator 158. The cam 1104 can contact a cam follower 1108, so that as the cam 1104 rotates, the cam follower 1108 also rotates (e.g., the cam follower 1108 rotates about an axis parallel to a shaft axis about which the cam 1104 is rotated by the shaft 602). The cam 1104 can be eccentric (e.g., have a variable radius relative to the shaft axis). The cam 1104 and cam follower 1108 can enable motion of the wings 154 to be synchronized and have a great degree of deflection. In some implementations, the profile of the cam 1104 can actuate the wings 154 once for each revolution of the shaft 602. The difference in radius between the smallest radius and largest radius of the cam 1104 can be maximized within the space constraints to maximize the angle of actuation for the cam follower 1108 connected to the wing 154 (e.g., to wing hub 504). The profile of the cam 1104 can make the motion of the wings 154 as smooth as possible: the transitions between the low and high points of the cam 1104 can be long and smooth to prevent jerkiness in the wings 154. In some implementations, the cam 1104 can drive the wings 154 twice per revolution, thus doubling the flapping speed of the wings 154. The cam 1104 can have relatively lesser differences between the smallest and largest radius, which can decrease the angle that the wings 154 move, while enabling an increased frequency of actuation to create a “fluttering” effect. The shape of the cam 1104 can have cuts or sharp transitions between radii to give the wings 154 different kinds of motion. The cam follower 1108 can drive a first wing shaft 1204 coupled to a first wing hub 504, to cause the first wing hub 504 to shift from a first position 1300 as depicted in FIG. 13 to a second position 1400 as depicted in FIG. 14. The first wing hub 504 can be coupled to a second wing hub 504 (e.g., via gears 1204, 1208) to enable coupled motion of the wings 154. As such, the second wing hub 504 can also move from the first position 1300 to the second position 1400.

In some implementations, each wing 154 includes a biasing member, such as a torsion spring (not shown) at the pivot point. The biasing member can return the wings 154 to the first position 1300 after being driven to the second position 1400 by the cam 1104. The biasing member can also improve aesthetics of the motion of the wings 154 while mitigating a risk of items being caught between the wings 154 and the body 186 (e.g., pinching of hair).

Referring now to FIG. 15, an implementation of a cam 1504 is depicted. The cam 1504 can be used in the drive system 1100. The cam 1504 includes a plurality of relatively lesser radius portions 1508 and a plurality of relatively greater radius portions 1512. As such, the cam 1504 can enable varied fluttering motion of the wings 154.

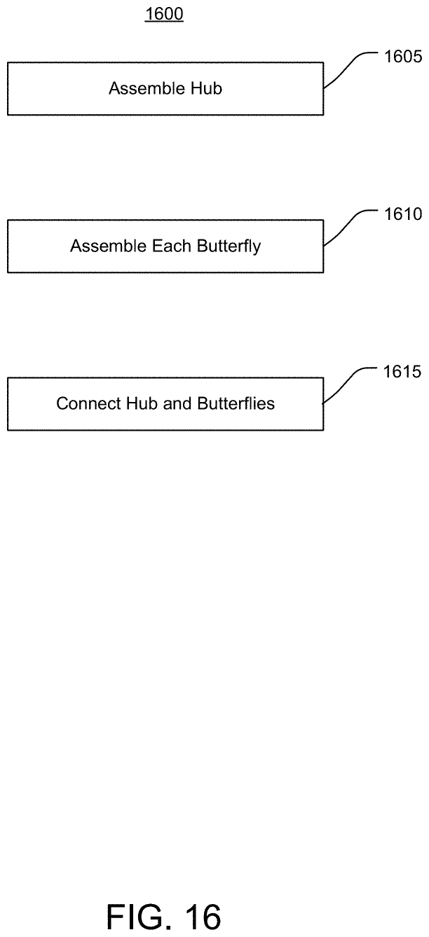

Referring now to FIG. 16, a method 1600 for assembling an IoT connected education system, such as a butterfly wall, is depicted. The method 1600 can be implemented using various systems described herein, including the system 100. The method 1600 can be performed to enable a user to learn aspects of mechanical and electrical design and engineering in a readily understood manner. Components used to assembly the system can include written and graphical descriptions to guide the assembly process and provide a non-intimidating experience, including an introduction to STEM concepts, including electronics concepts. The method 1600 can include assembling the system using relatively large-scale connectors, to reduce the risk of components breaking during multiple assemblies and facilitate hand-held manipulation of the components (e.g., as compared to using press-fits, snap fingers, glue, or very tiny screws).

At 1605, a hub of the system is assembled. Assembling the hub can include coupling one or more processing circuits of the hub to a housing of the hub. For example, a hub PCB can be coupled to the housing by locating two holes and a slot in the hub PCB with three posts in the housing. The one or more processing circuits can include a microprocessor coupled to a communications interface. Assembling the hub can include coupling connection cables to the one or more processing circuits, such as interconnect wire harnesses. Assembling the hub can include coupling a plurality of user input devices to the housing (and the one or more processing circuits, such as using connection cables), such as a mode switch, an on/off switch, and a plurality of potentiometers (as well as associated PCBs of these components). Assembling the hub can include coupling a power supply, such as a battery pack, to the housing. Assembling the hub can include coupling the hub to a remote power source (e.g., coupling a power adapter to mains power, such as via a wall outlet). Assembling the hub can include coupling a hub cover to the housing, such as using a toe-in feature and a plurality of screws.

At 1610, at least one interactive device, such as a butterfly or other such device, is assembled. Assembling the interactive device can include coupling a first processing circuit of the interactive device to a body of the interactive device. Assembling the interactive device can include coupling a pair of moving components to the body, such as wing hubs, and coupling one or more moving component segments, such as wing segments, to each wing hub. Assembling the interactive device can include coupling an actuator, such as a DC motor, to the body of the interactive device, and coupling a drive system between the actuator and the wing hubs. By coupling the drive system between the actuator and the wing hubs, a flapping motion of the wings can be enabled. Assembling the interactive device can include coupling a cover to the body, so as to hide features of the interactive device such as the drive system, the actuator, gears of the wings, biasing elements, and various electronic components and connectors. In some implementations, coupling the cover to the base includes aligning at least one magnet of the cover with at least one magnet of the base.

At 1615, each interactive is coupled to the hub, such as through a wired or wireless connection. For example, if the at least one interactive device includes three interactive devices (e.g., three butterflies), a first cable can be connected between the hub and a first interactive device, a second cable can be connected between the first interactive device and the second interactive device, and a third cable can be connected between the second interactive device and a third interactive device.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The embodiments of the present disclosure may be implemented using computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed:

1. A system for an Internet of Things (IoT) connected educational system, the system comprising:
a hub includes at least one user input device, a processing circuit, and a communications circuit;
wherein the processing circuit is configured to receive a user input via the at least one user input device and generate a control signal to control operation of the at least one interactive device based on the received user input;
wherein the at least one interactive device includes a body coupled to one or more moving components, an actuator coupled to a drive system coupled to each moving component, a plurality of lighting elements, a plurality of input sensors, and a control system to drive various inputs and outputs of the interactive device;
wherein a processing circuit of the interactive device is configured to receive the control signal and control operation of at least one of the actuator or the lighting elements based on the control signal.

2. A method for assembling Internet of Things (IoT) connected educational system, the method comprising:
coupling one or more processing circuits to a hub housing;
coupling at least one user input device to the one or more processing circuits;
coupling, for each of a plurality of interactive devices, one or more processing circuits, a power supply, an actuator, and a drive system to a body of the interactive device
